(19) United States
(12) Patent Application Publication
(10) Pub. No.: US 2026/0329561 A1
(43) Pub. Date: Oct. 22, 2026

(54) SYSTEMS AND METHODS FOR HEAD-FIRST TRANSFORMATIONS OF LEGACY CODE

(71) Applicant: MongoDB, Inc., New York, NY (US)

(72) Inventor: Joerg Schmuecker, Zurich (CH)

(73) Assignee: MongoDB, Inc., New York, NY (US)

(21) Appl. No.: 19/726,708

(22) Filed: Jun. 30, 2026

Related U.S. Application Data
(63) Continuation-in-part of application No. 19/235,279, filed on Jun. 11, 2025.
(60) Provisional application No. 63/659,270, filed on Jun. 12, 2024.
(60) Provisional application No. 63/836,935, filed on Jul. 1, 2025.

(51) Int. Cl. G06F 8/51; G06F 11/3668

(52) U.S. Cl. CPC G06F 8/51; G06F 11/3676

(57) ABSTRACT

A system for transforming computer programs includes at least one processor operatively connected to a memory. The at least one processor, when executing, is configured to identify a plurality of slices from a plurality of programs, where a respective slice is defined as a subdivision of a respective program. The at least one processor is configured to input a first slice of the plurality of slices into a large language model trained to generate object-oriented code from input lines of code, and generate a transformed first code slice as output. The at least one processor is configured to test the transformed first code slice. Upon validation, the at least one processor is configured to continue transformation and testing of subsequent ones of the plurality of slices.

### RELATED APPLICATIONS

This Application claims the benefit under 35 U.S.C. § 119(e) of U.S. Provisional Application No. 63/836,935, filed Jul. 1, 2025, entitled “SYSTEMS AND METHODS FOR HEAD-FIRST TRANSFORMATIONS OF LEGACY CODE”. This Application claims priority under 35 U.S.C. § 120 to and is a continuation-in-part of U.S. application Ser. No. 19/235,279, filed Jun. 11, 2025, entitled “SYSTEMS AND METHODS FOR LLM-BASED CODE REFACTORING”, which claims the benefit under 35 U.S.C. § 119(e) of U.S. Provisional Application No. 63/659,270, filed Jun. 12, 2024, entitled “SYSTEMS AND METHODS FOR LLM-BASED CODE REFACTORING”. The entire contents of these applications are incorporated herein by reference in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Legacy code exists in almost every system and implementation. Legacy code refers to old software codebase often developed using outdated approaches, technologies, or practices. Legacy code can belong to systems or technology stacks that are no longer actively maintained, supported, or even compatible with current standards. Although such code does still provide business value, it has become hard or even impossible to maintain efficiently. Many instances of legacy code are simply unable to integrate with modern systems and/or lack documentation on how it works, exacerbating integration issues. To meet current requirements and enhance performance, legacy code is often updated ad-hoc, which simply pushes problems down the road (and may even increase the integration burden later). Nevertheless, complete independent rewrites of existing systems often fail because of the complexity of the domain and many other dependencies.

### SUMMARY

Various aspects are directed to implementation of a novel approach to a test-first legacy code conversion, and for example, conversion of stored procedures or COBOL. Systems and methods provide the capability to modernize legacy code implementation while reducing later integration issues. The system is leveraging regression tests, which are executed by comparing the side effects and results of the transformed code against the original reference code. Side effects include, but are not limited to, return values, changes to other components, and changes to the internal state of the system under transformation. Side effects can also include so-called non-functional side effects such as time consumption or resiliency. According to some embodiments, the conversion involves incrementally converting from procedural languages into other languages, including but not limited to object-oriented languages (e.g., PL/SQL to Java, among other examples). Each incremental conversion is configured to add more functionality while keeping the translated code testable, either manually or automatically. Keeping the testable unit limit, the translation itself is simplified directly, and the translation can be easily verified. In one embodiment of the system and method, the translation is performed by leveraging stochastic translation methods such as generative AI models. The limited scope of code to be translated reduces the required context for the model while also improving the reliability of the translation significantly. Furthermore, the result of the tests can be used as input to a so-called Build/Repair loop, which allows for the repair of any translation errors. The repairs can be performed by another system, such as a generative AI model or a human, or a combination of such techniques and technologies. In another embodiment, the translation can be performed by humans.

According to one embodiment, the system identifies slices in the original source code that can be translated either automatically, manually, or by a combination of mechanisms. For each slice, the system constructs a regression test by starting the code from the entry point until the end of a given slice, both on the legacy code as well as the translated code. Assuming a set of slices numbered 0-n, regression tests would be constructed iteratively for head 0, which would be composed of only functionality up to the end of slice 0, head 1, which comprises source code up to the end of slice 1, and so forth. In another embodiment, the slices are not linearly numbered. This can be advantageous when code branches need to be translated individually.

In some embodiments, slices are selected automatically by the system using mechanisms such as parsers. In other embodiments, the system relies on externally provided slicing. In a further embodiment, slices are iteratively generated depending on the quality of the translation mechanism used. In an adaptive slicing scheme, the system generates an incremental slice including the necessary regression test. After translating the slice and composing the heads in the source and target technology, the tests are evaluated, and in case of detecting a translation error, the method or system splits the slice into smaller pieces and uses these pieces for a repeated translation attempt. Adaptive slicing can be executed using different systems or methods. In one embodiment of the system, a manual slicing strategy is defined by a human. In other embodiments, the slicing strategy is fully automated. According to one embodiment, a hybrid approach is used where slices are proposed by the system and then confirmed manually. Other embodiments can use manual slicing initially, where resulting slices are then automatically sliced smaller in case of test failures.

In one embodiment of the system, each head is finished by additional statements that increase the observability of state changes otherwise internal to the system. For example, a change in the value of an internal variable can be made observable by the regression test by returning the value of the variable from the code under transformation. Other embodiments use standard journaling or logging mechanisms. Side effects such as CRUD operations on a data storage system such as a database, a file system, or potentially user interface outputs are included in the regression by using suitable technical means.

The above-described transformation system and method can be performed iteratively until the translated slices cover the capabilities of the chosen source code artifact. The system can be used for verbatim transformation of the source code into other languages, technologies, and architectures. It can furthermore be used to move functionality from one system to another system. In one embodiment, the system can be used to migrate from monolithic to distributed architectures and technologies. The system is also effective in supporting the re-architecting of systems.

Embodiments of the system and method can be used to support storage model changes such as conversion from relational data storage schemas to hierarchical or columnar storage mechanisms. The system and method are not limited to these storage mechanisms.

The system allows for refactoring the target code after each translation stage while providing the required testing capabilities to support refactoring or re-architecting activities. In one embodiment of the system, this is used for performance optimizations and data model adjustments.

According to one embodiment, the system is configured to leverage GenAI models to convert Oracle PL/SQL stored procedures to Java, supported by a MongoDB backend. Various examples are described, and some examples omit any subsequent steps required to support a denormalized document model, refactoring of the Java code for optimization, or refactoring to be aligned with microservice bounded contexts, to facilitate understanding of the transformation approach.

In one embodiment, the slicing strategy is used to create iterative regression tests for subroutines, functions, procedures, methods, or other ways of control flow statements, such as conditions and loops.

Still other aspects, embodiments, and advantages of these exemplary aspects and embodiments are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE FIGURES

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIGS. 1A-1B show a block diagram of an example process flow, according to one embodiment;

FIG. 2 is a block diagram of an example of a slice identified as the starting point for transformation, according to one embodiment;

FIG. 3 is a block diagram of an example process flow, according to one embodiment;

FIG. 4 is a block diagram of an example process flow, according to one embodiment;

FIG. 5 is a block diagram of an example process flow, according to one embodiment;

FIG. 6 is a block diagram of an example process flow with nested procedure calls, according to one embodiment;

FIG. 7 is an example dependency graph, according to one embodiment;

FIG. 8 is a block diagram of an example special purpose computer system improved by the functions and/or processes disclosed herein;

FIG. 9A, B, and C show an example of SQL code slices with added return handling;

FIG. 10A is a flowchart showing SQL code parsing to an abstract syntax tree, slice generation, and iterative testing, according to one embodiment;

FIG. 10B is a block diagram of generated source code comprising Java source code slices and SQL slices organized in a folder structure, according to one embodiment;

FIG. 11A is a flowchart of an execute test suite process with Oracle and MongoDB comparison, according to one embodiment;

FIG. 11B is a JSON document structure representing a dynamic execution configuration and associated metadata, according to one embodiment;

FIG. 12 is a flowchart of a dynamic SQL translation process with multiple permutations, according to one embodiment;

FIG. 13A is a flowchart of a head-first transformation process for static SQL, dynamic SQL, conditional SQL, JOIN, and nested SQL handling, according to one embodiment;

FIG. 13B is a code parsing and transformation diagram showing stored procedure decomposition into structured data representations, according to one embodiment;

FIG. 14A is a flowchart of an invoke the flow process during legacy code transformation, according to one embodiment;

FIG. 14B is a flowchart of a loop process to write slices during legacy code transformation, according to one embodiment; and

FIG. 14C is a flowchart of a head-first transformation process for converting legacy code, according to one embodiment.

### DETAILED DESCRIPTION

Various embodiments provide systems and methods for executing a head-first transformation of stored procedures into object-oriented programming languages (e.g., Java). According to some embodiments, complex stored procedures are segmented into slices or blocks that can be tested incrementally. The slicing algorithm can be based on upfront analysis of the existing code base. Such analysis can be performed through parsers or other deterministic mechanisms, as well as through non-deterministic mechanisms such as generative AI or machine learning.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element, or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

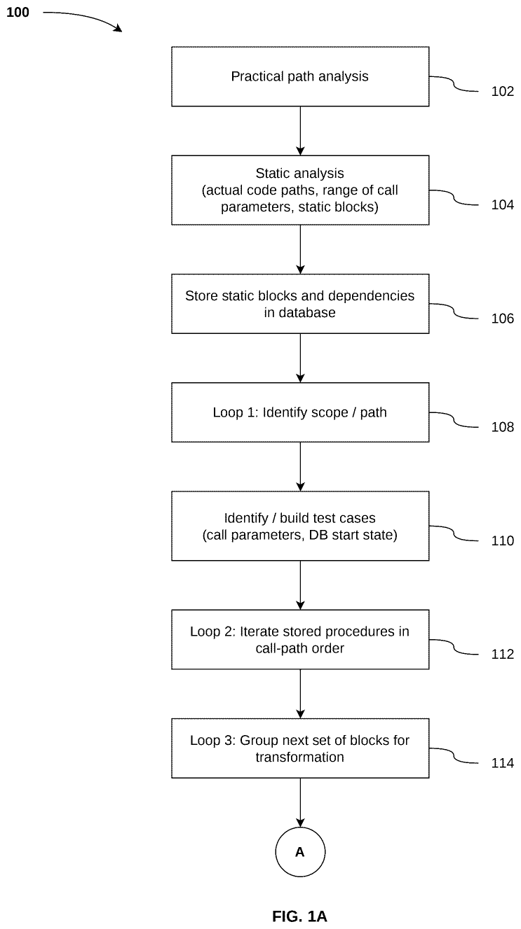

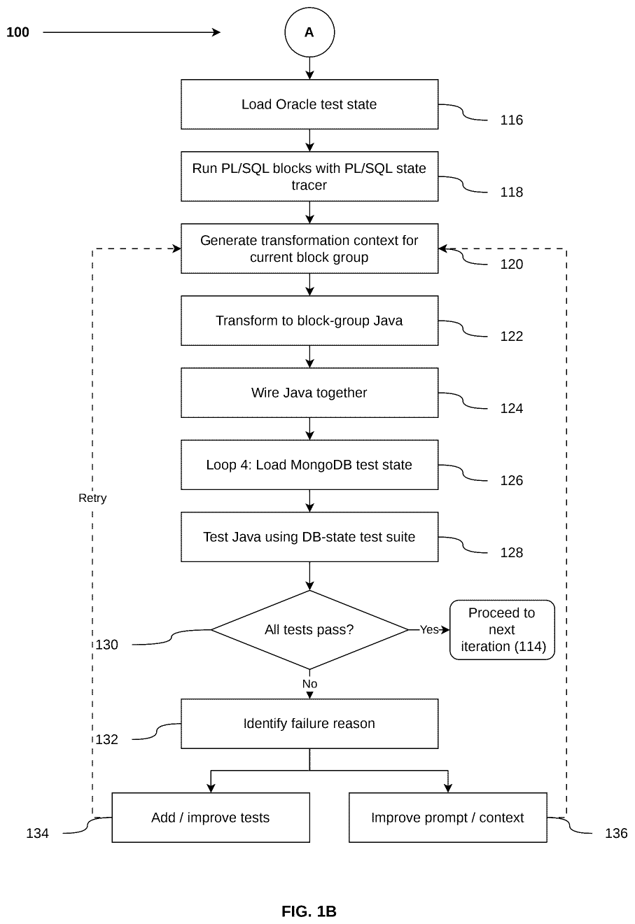

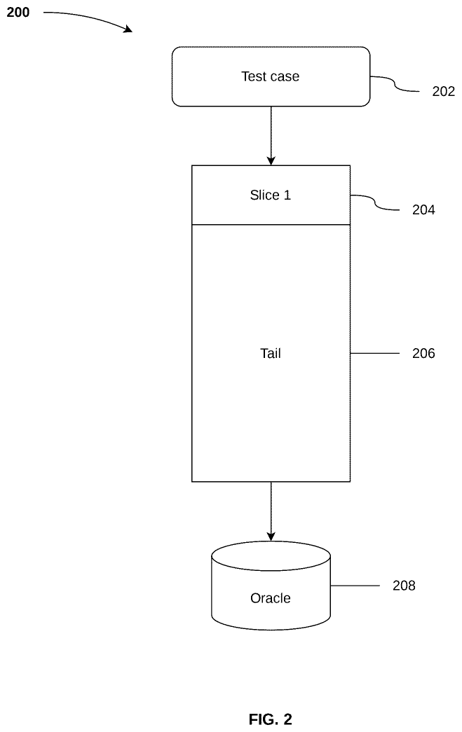

FIGS. 1A-B show an example block diagram of a process flow 100. According to various embodiments, process 100 can be executed to transform legacy code, including stored procedures in an object-oriented programming language (e.g., Java). Once a first slice is generated, it can be translated by using the first slice as an input to a code generation model (e.g., a large language model), which may be accompanied by prompts (e.g., including captured state information or other metadata associated with the original source execution).

As shown, process 100 begins with an analysis of input code to derive smaller structural units called slices. Slices may be selected automatically by the system using mechanisms such as parsers. In other embodiments, the system relies on externally provided slicing. In a further embodiment, slices are iteratively generated depending on the quality of the translation mechanism used. In an adaptive slicing scheme, the system generates an incremental slice including the necessary regression test. After translating the slice and composing the heads in the source and target technology, the tests are evaluated, and in case of detecting a translation error, the method or system splits the slice into smaller pieces and uses these pieces for a repeated translation attempt. Adaptive slicing can be executed using different systems or methods. In one embodiment of the system, a manual slicing strategy is defined by a human. In other embodiments, the slicing strategy is fully automated. According to one embodiment, a hybrid approach is used where slices are proposed by the system and then confirmed manually. Other embodiments include manual slicing initially, which then can be automatically sliced smaller in case of test failures.

According to some embodiments, the system leverages Abstract Syntax Tree (AST) analysis to decompose complex SQL statements into manageable units. In one embodiment, statements are identified by building an abstract syntax tree using a parser, such as an ANTLR parser for PL/SQL. The AST analysis enables the system to identify lineage and dependencies within each SQL statement, including parent, child, and grandchild relationships between code elements. In various embodiments, processing constraints are applied such that parent elements are processed before child elements, enabling progressive transformations that maintain referential integrity across slice boundaries. Each slice may represent a discrete, atomic unit of business logic, and the system may utilize a deterministic approach to identify and sequence procedural elements.

In some embodiments, the slicing strategy handles conditional branches by decomposing them into separate slices. For example, a conditional statement may be decomposed as follows: a first slice evaluates the condition, a second slice (e.g., Slice 2A) handles the TRUE branch, and a third slice (e.g., Slice 2B) handles the FALSE branch. This approach enables independent testing and transformation of each branch path, simplifying debugging when test failures occur in conditional logic.

According to one embodiment, an analysis is conducted to develop an understanding of the call paths executed by the application (these call paths are used as a subset of the entire range of possible paths identified during static analysis), and the PL/SQL is parsed and decomposed into slices. Different boundaries for defining the slices can be used. In various examples, procedures and functions become slices, and each statement within can be encoded as slices as well. In some embodiments, the dependencies defined in the original source are captured as well. The dependencies can be based on identifying where one procedure invokes another procedure, and separately building slices in each case, as discussed in greater detail below.

According to one embodiment, the slices are stored in a database representation (e.g., MongoDB) that provides the foundation for the code transformation process and for tools used to generate human-readable visualizations and documentation of PL/SQL business logic contained or derived from the original code. For the stored procedures, the analysis identifies and captures information on nested stored procedures, what tables/views it performs CRUD operations on, and what other stored procedures consume this stored procedure. Various embodiments are configured to identify for a procedure what it depends on and what depends on it to ensure other unforeseen components are also appropriately pulled into the conversion process. The inventors have realized that identification of dependencies (depends on and depends on it) in this context enables the system to capture unforeseen components, improving over conventional implementation. Once the analysis is complete, a multi-loop stage is entered.

Head-first refers to a depth-first walk through the legacy code (e.g., PL/SQL code) to transform the stored procedures. In some examples, the transformation function transforms stored procedures to object-oriented programming (e.g., Java) stored on a dynamic or flexible schema database (e.g., MongoDB). Testing can be executed incrementally along the way.

Examples of earlier implementation are configured to (1) break long stored procedures into smaller blocks that could be transformed to Java by LLMs accurately (50 lines or less); (2) transform slices to Java one at a time, where the Java was generated for Oracle; the approach read and updated Oracle during execution (the migration to other databases (including, for example MongoDB was and can be postponed to later steps); (3) wire the Java slices back together to form the Java version of the stored procedure; and (4) test the Java version of the stored procedure by comparing its execution to the PL/SQL version.

In various embodiments, the looped transformation resolved issues with execution that simply broke code into a number of lines as a slices building approach. For example, the pathway defined by 1-4 encountered difficulties in testing and debugging the Java version of the stored procedures when the block building approach was not sufficiently fine-tuned, among other issues. Some other issues include resolving the “unknown amount of needles in the haystack” problem in that human engineers often need to spend a significant amount of time debugging large sections of machine-generated code. Some embodiments were successful on partitioning stored procedures on a number of lines basis (with iterative testing, and functionality described herein) and thus improve over conventional implementation.

Although FIGS. 1A-B illustrates an example process, other embodiments can be executed in a different order, omit steps, consolidate steps, among other examples. According to another embodiment, a process for head-first transformation does not start with slices. For example, the slices can be generated at any point in the process prior to the transformation, and in other examples, are generated iteratively. In further embodiments, upfront analysis is not required for a head-first approach.

According to some embodiments, the head-first approach was implemented to mitigate a number of challenges present when transforming legacy code with stored procedures (e.g., PL/SQL, T-SQL, etc.) to Java:
1. Many legacy applications contain constructs such as PL/SQL procedures that are too large to transform in a single monolithic transformation step. In particular the probability of translation errors by LLMs and humans increases significantly with increasing size of the code fragmented to be translated; decomposing the translation into translations of smaller code segments has been shown to reduce the error rate of the translations
2. Code bases in legacy and modern systems can include a nested web of procedures and functions calling other procedures, functions, or otherwise different code fragments. These dependencies create challenges for a direct translation as the complexity of the dependencies increases. By extending the iterative head-first approach onto dependencies, the benefits of an iterative translation approach can be extended to complex systems.
3. To reduce the amount of transform/test cycles, the looped transformation enables the generated Java running on dynamic/flexible schema databases (e.g., MongoDB) to operate at early/optimal stages.

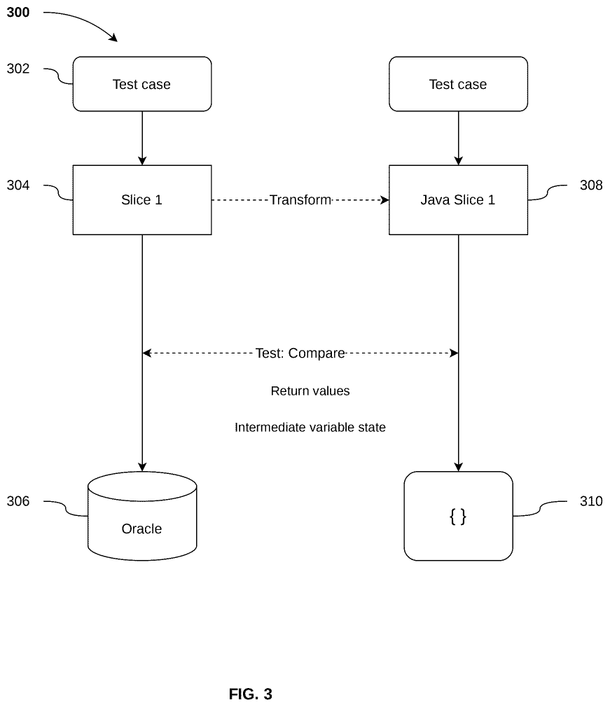

In one embodiment, the “head-first” transformation process starts with a PL/SQL procedure. A first slice is identified to begin the transformation that has been decomposed into blocks (FIG. 2). The terms blocks and slices are used to describe various example implementations. The functionality discussed herein with respect to blocks and/or slices can be used interchangeably with the examples describing either blocks or slices, unless explicitly constrained to a described example.

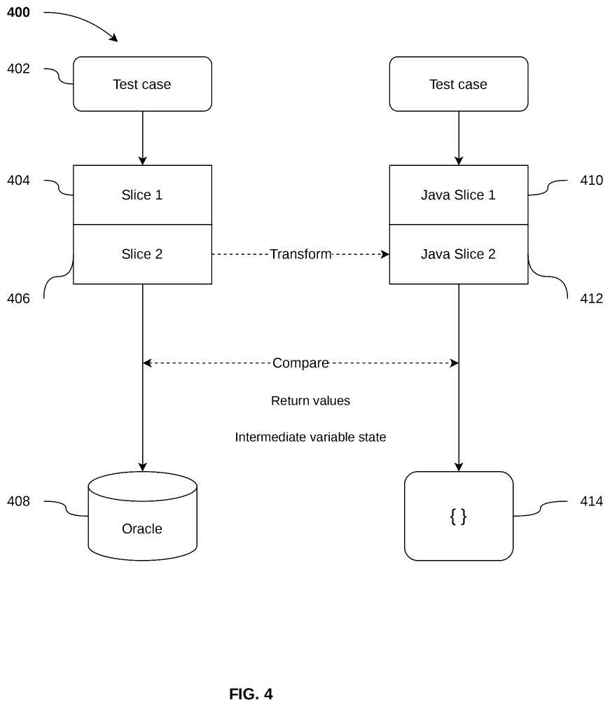

FIG. 2 illustrates process 200 for decomposing code into slices as the starting point for transformation. As shown, a test case 202 provides input to a stored procedure that is divided into a first slice 204 and a tail 206, where the first slice 204 represents the portion of code selected for transformation and the tail 206 represents the remaining untransformed code. Execution of the stored procedure operates against an Oracle database 208. Process 200 can begin by transforming the first slice 204 into Java and testing it by comparing the execution of the PL/SQL version to the Java version for the same test case 202 (see FIG. 3). Specifically, execution validates that the return values, any intermediate variables, and the final database state are identical between the original to the transformed block.

FIG. 3 illustrates process 300 for processing of a first slice, including transformation and validation on return values, any intermediate variables, and the database state (e.g., are identical). As shown, a test case 302 drives execution of a first slice 304 of original code against an Oracle database 306, and drives execution of a transformed first slice 308 against a document data store 310. The first slice 304 is converted into the transformed first slice 308 by a transform operation, and the executions are validated by a compare operation that checks return values and intermediate variable state for equivalence between the original and transformed code.

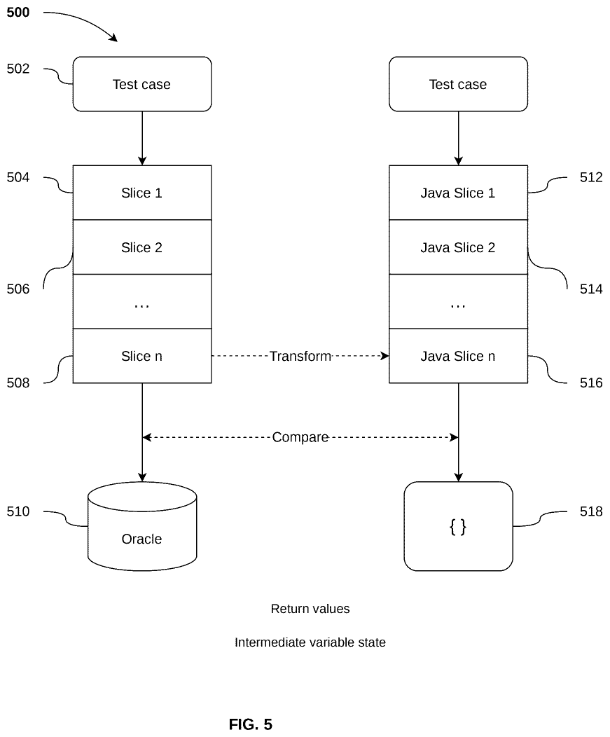

FIG. 4 illustrates process 400 for the transformation of the next slice (slice 2), and validation. As shown, the next block is transformed and tested the same way (FIG. 4) and a test case 402 drives execution of a first slice 404 and a second slice 406 of the original code against an Oracle database 408, and drives execution of a transformed first slice 410 and a transformed second slice 412 against a document data store 414. The second slice 406 is converted into the transformed second slice 412 by a transform operation, and a compare operation validates return values and intermediate variable state between the original and transformed code. In various embodiments, each new slice is tested in combination with the preceding slices. For example, when testing, the PL/SQL execution of blocks 1 and 2 are compared to their corresponding Java versions (e.g., Java Block 1 & 2). According to various embodiments, debugging is simplified because if any of the tests fail (after validation of the prior block), it is known that the issues were introduced during the next block transformation (e.g., block 2).

According to various embodiments, the side-by-side testing comparison validates multiple aspects of equivalence between the original and transformed code execution. The comparison criteria may include data content equivalence to verify that the actual data values match, type matching to ensure data types are preserved correctly, result set size to confirm the same number of records or elements are returned, order preservation when the original code specifies ordering, NULL handling to verify that NULL values are treated consistently, and error conditions to ensure that error states and exceptions are handled equivalently. In some embodiments, the system implements two distinct test runs: a SQL-to-Oracle test executing the original code and a transformed Java-to-MongoDB test executing the converted code, with results from both recorded and compared.

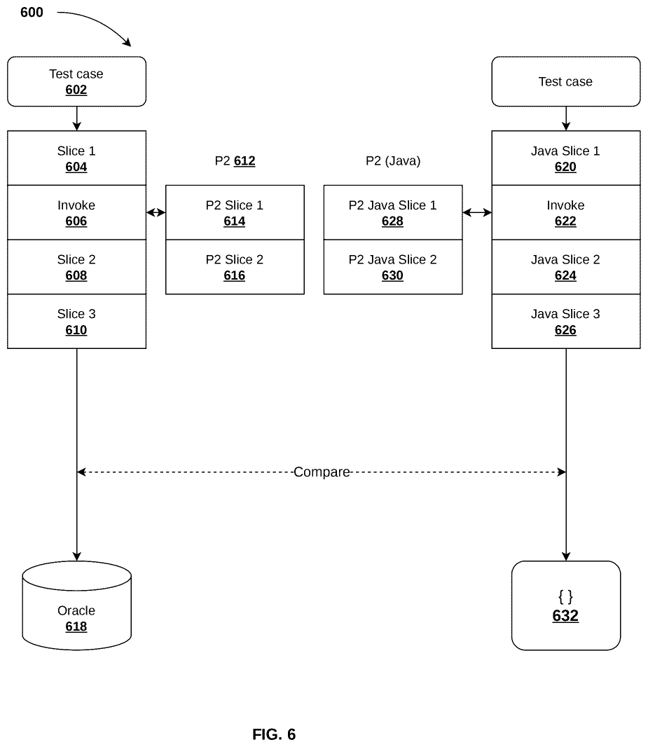

According to one embodiment, the approach is repeated until the entire stored procedure is converted (FIG. 5). FIG. 5 illustrates an example of a successive transformation process. In further embodiments, the head-first transformation process can be leveraged when a stored procedure invokes another stored procedure or function (see FIG. 6). For example, as shown in FIG. 6, in the diagram after Block 1 is transformed and tested, then Block 1 of stored procedure P2 would be transformed and tested. This process would continue with P2 Block 2 and then continue on with Block 2 in the original stored procedure. As shown in FIG. 5, a test case 502 drives execution of a first slice 504, a second slice 506, through an nth slice 508 of original code against an Oracle database 510, and drives execution of a transformed first slice 512, a transformed second slice 514, through a transformed nth slice 516 against a document data store 518. Each slice is converted into its transformed counterpart by a transform operation, and a compare operation validates return values and intermediate variable state between the original and transformed code. In further embodiments, the head-first transformation process can be leveraged when a stored procedure invokes another stored procedure or function (see FIG. 6).

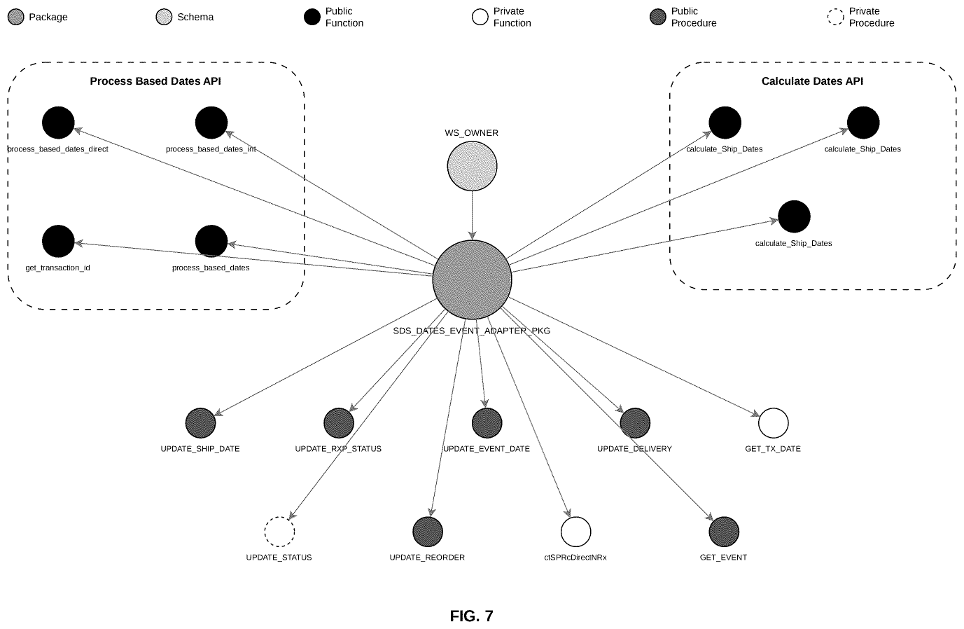

For example, as shown in FIG. 6, process 600 illustrates nested procedure calls where a test case 602 drives execution of a first slice 604, an invoke operation 606, a second slice 608, and a third slice 610 of original code, where the invoke operation 606 calls a nested procedure 612 having a nested first slice 614 and a nested second slice 616, and the execution operates against an Oracle database 618. A corresponding transformed implementation includes a transformed first slice 620, a transformed invoke operation 622, a transformed second slice 624, and a transformed third slice 626, where the transformed invoke operation 622 calls a transformed nested first slice 628 and a transformed nested second slice 630, and the execution operates against a document data store 632. A compare operation validates equivalence between the original and transformed code. FIG. 7 is an example dependency graph that can be generated.

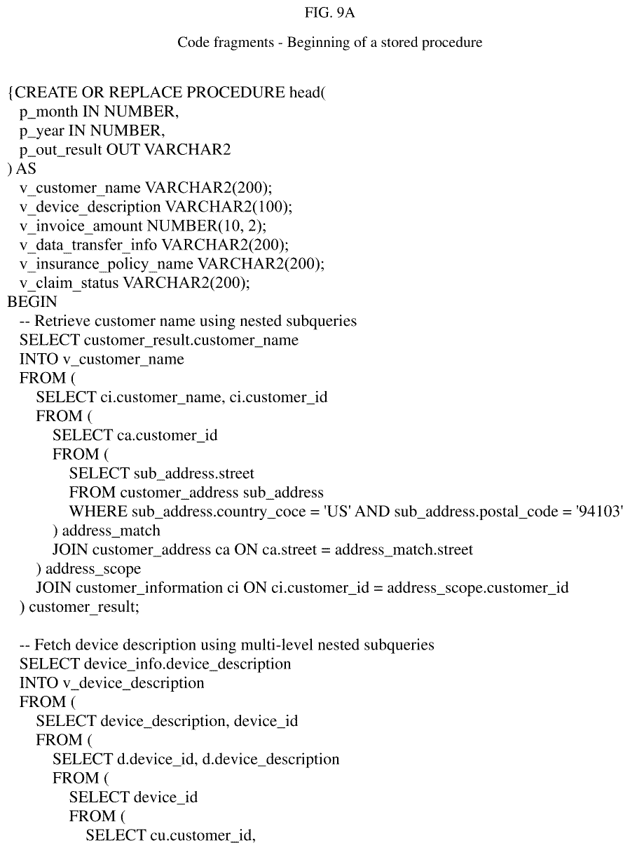

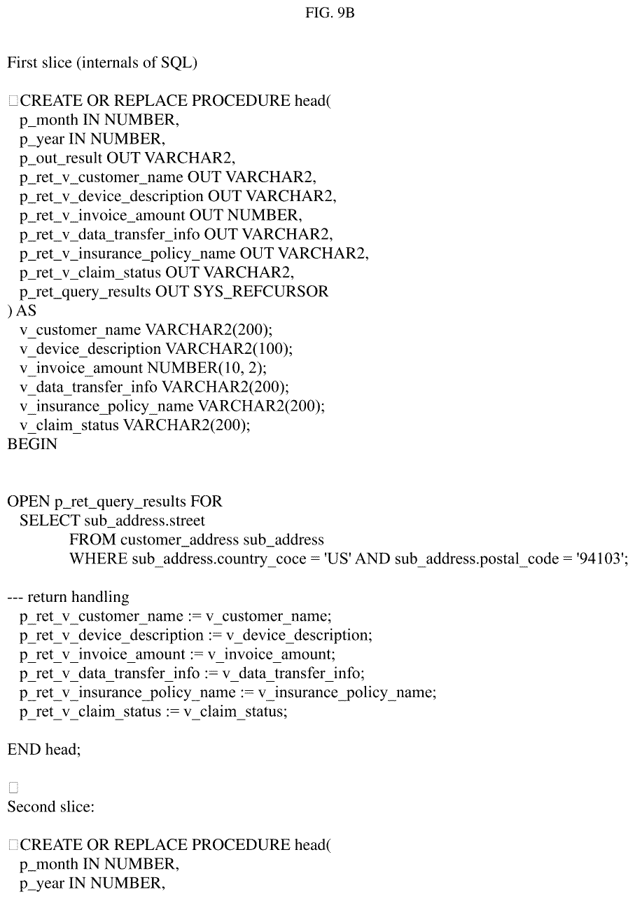

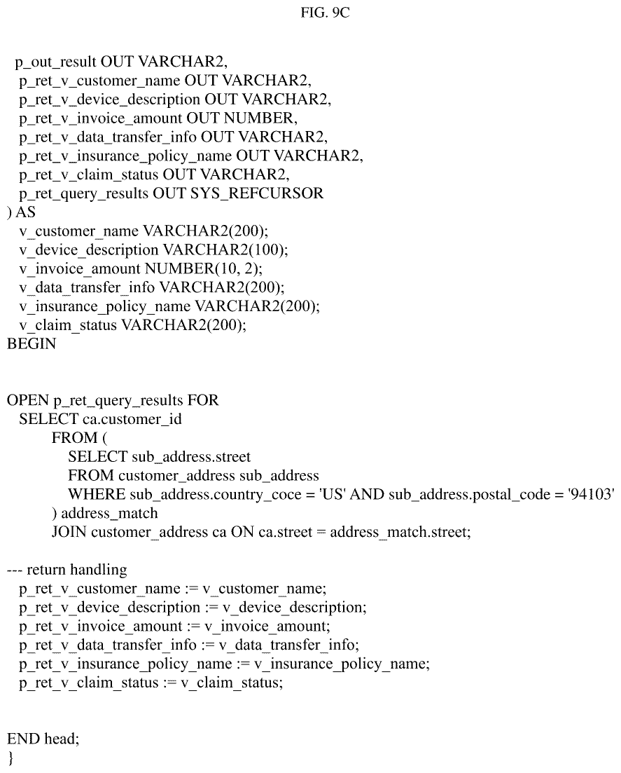

To make the side effects observable, a SQL code block can be extended to return variable values and return values, e.g., as cursors. Equally, when a block is converted, for example, to Java, there may be some additional code that needs to be added to the Java block to make it immediately testable. For example, return statements can be added to return intermediate variables, and special handling can be implemented to capture the state of conditional blocks or cursors. FIG. 9 illustrates example code slices.

In some examples, this code can be added manually or by using a trained model (e.g., an LLM). In other examples, test state functions (e.g., ORACLE test state) can be used to determine intermediate variables as well as a tool for logging database changes caused by stored procedure execution to identify state for conditional blocks or cursors. Automatic operation can include specifying prompts regarding common issues (e.g., add return statements, identify intermediate variables needed, access variables at (storage location), among other options. Alternatively, the code extension can be generated based on the results of a parser. In various embodiments, finishing operations can be implemented using generative AI, and include construction of the additional code, identification and provision of intermediate values, addition of return variables/statements, among other options. In further embodiments, additional information can be leveraged as inputs to a model for transformation code slices. In some examples, the quality of the Java output for each slice can be improved by including the following additional information as part of the prompt:
1. Pseudo code description of the slice (generated by a LLM (e.g., can be executed previously));
2. Text description of the slice functionality (generated by a LLM (e.g., can be executed previously));
3. Some context or description of the previous slices to help ensure that the LLM generated code works seamlessly with the code for those slices; and/or
4. the code for the previous slices
5. relevant example code that instructs the translation engine to generate code that is appropriate for the desired target architecture and code style.

According to some embodiments, the above additional information can be used individually, selectively, or in any combination. For example, the additional information can be used after a failed test shown in FIGS. 1A-B.

In further embodiments, the loop transformation process takes a head-first test-driven approach towards modernization and the process diagrammed in FIGS. 1A-B is explained in a step-by-step fashion to identify for each step: examples of the implementation used. To facilitate understanding, additional considerations and examples are provided. Additional implementation details are described with respect to the loops in the four loop process. In loop one, the functionality is configured to iterate over test scenarios. In loop one, execution begins by looping over a test scenario. In some examples, the loops can be executed manually, implemented as part of the transformation tool, or leveraged using an integrated development environment (“IDE”) based transformation process or by any other means of execution. According to one embodiment, the looped transformation is supported by test scenarios consisting of the following elements: the starting Oracle database state (test data); a mechanism to copy the data from the source storage medium to the target medium for example from Oracle to MongoDB. In other embodiments, the test scenarios created the required starting state of both source and target system programmatically.

Alternative embodiments are using database transactions or other storage mechanisms with roll-back capabilities to ensure repeatable consistent state for all test scenarios. In another embodiment, side effects are limited to a specific section of the storage mechanism and can be reverted by resetting the affected part of the storage system. In other embodiments, all side effect operations are overwriting prior side effects and thereby keep the comparability of the state in place. In some examples you can use the list of tables touched by each stored procedure captured during analysis to identify the subset of application state that is required to run the regression tests that is migrated to MongoDB for the test; a mechanism to return Oracle to the start state after running a test. Some embodiments use one or both of two common approaches: a backup and restore process or start a transaction at the start of a test and rollback at the end; a mechanism to return MongoDB to the start state after running a test; and the parameter values necessary to invoke the top-level stored procedure to kick off execution.

In other embodiments additional loops are added to facilitate additional steps to validate different aspects of the code. In one embodiment, the code transformation stage was followed by a build/repair stage to handle syntax errors introduced in the non-deterministic code translation. In another embodiment, the system used a linter and subsequent automated code quality improvement state after which an additional test run was included.

### Example Implementation and Considerations

According to some embodiments, the transformation system is configured to implement block testing based on execution at an application level. Although some examples include lower level tests for debugging, the application level testing can often provide a better equivalence on a functional level. Described are sample architecture and acceptance testing for application level execution.

Acceptance testing is done to discover functional defects in the application, and is implemented in various embodiments to validate a correct transformation as part of the modernization project. Acceptance testing validates application behavior-check that the application is consistent when given events happen. An application can react to events in 2 ways: synchronously or asynchronously. The external behavior of an application is then defined by the return value to synchronous calls, messages emitted from the application, service calls made by the application. Many operations also result in internal state changes in the application that are not directly observable, in these cases, tools can be executed to probe the application for when these changes have happened by interacting with the application in different ways. For example, if testing order processing, then a web based implementation can acknowledge the receipt of the order and send a message to the shipping service after recording the new order in its internal database. The record of the order in the internal database is defined such that 1) a customer can see his last orders, 2) to allow purchase suggestions to be displayed correctly and to 3) train the recommendation engine. The testing ensures that all of these capabilities are still there after the change by: 1) use the “getLastOrders( )” call to receive the last order back from the application and validate that the order is in there, 2) query for “getRecommendations( )” and ensure that the order is included in the last orders that are sent to the recommendation engine, and 3) ensure that the order is included in the results that the recommendation engine will receive when it calls “getYesterdaysOrders( )”

Directly asserting that the data in the database has changed would not be a valid acceptance test, as these queries would stop working when we transition to MongoDB. According to some embodiments, testing with a database as the interface can be accomplished by comparing the changelog and validating (e.g., MongoDB generates a changelog as part of native operation). If performance or “change simplicity” are relevant for the installation, then changing the data model and the data access layer can be done during the transformation but also once the functionality is in the application layer. This was successfully done in various examples described below:

In the example, the reasons supporting the approach include: a) by breaking transformation into the small steps system creates better “agents” to execute these steps;. b) no requirement for understanding how the model should look in advance; c) most use cases are performant even if 1:1 (table to collection); d) refactoring in Java is well understood, while doing so SQL is hard or can be intractable. Although 1:1 table to collection is used initially denormalization of the data model should be considered. In particular the use of dynamic SQL might be an indication that denormalization should be executed

In various embodiments, automated testing can be used. Automated tests provide the safety net that allows translation of the application code to the new technology and equally enables refactoring to optimize on the target platform. Many legacy applications do not have sufficient automated end-to-end testing. Various examples provide for creating automated tests and can accelerate transformation accordingly. In order to transfer the business logic into the application layer, the embodiment below describes an example process to execute.
1. Selecting (grouping) the next set of statements (slices) to transform as a unit. For example, if the next set of PL/SQL statements is a sequence of variable assignments or a short if-then-else statement (<50 lines), these may be transformed together as a single group of blocks.
2. Closing the code slice by adding a logging statement to capture the changing variable state to the output parameters of the procedure.
3. Recording the behavior of the PL/SQL. The code executed consists of all the procedures and functions on the current call path up to and including the current slice group being transformed. A JSON document that summarizes all the database changes made by the PL/SQL execution can be created. In loop 4, compare this JSON document to the analogous JSON document produced by a similar tool designed to capture the changes made by a Java MongoDB application. Two identical (similar) JSON documents means success, i.e., the Java is functionally equivalent to the PL/SQL (at least for the scope of the current test).
4. Transform the slice to Java with the transformation prompt, called the context. When asking a LLM to transform the code for a PL/SQL block group, the LLM can leverage some information about the preceding slices so that it improves generation of code that works with those slices. The supplied prompts can include text description, pseudo code, or even the actual code for the preceding blocks. Each option and/or combination of options can be implemented. Over time the LLM, outputs, and results can be used to select a best-fit approach.
5. Transform the slice group to Java. This includes creating a prompt that consists of the slice group code, the context generated in step 4, instructions to the LLM, etc.
6. Once the Java code has been generated, the java for the code slice needs to be appended to the already existing Java code for the preceding part of the stored procedure. In other examples, newly generated transforms are wired together with the existing java code for the preceding elements on the call path. In various examples, this can occur manually or based on an output produced by an LLM. In addition, some embodiments include addition of some Java code after the transformed code for the last slice group to make the java code executable or to log the values of intermediate variables. For example, the additional code can include code to resolve compilation errors.
7. (Optional) Automating the integration of the transformed code into the target project structure. In some embodiments, the system automatically updates the Java project with each newly transformed slice. For example, as each slice is transformed, the corresponding Java method or class is added to the project, and the main execution path is updated to invoke the new slice in sequence with previously transformed slices. This automated project update reduces manual integration effort and ensures consistency across transformation iterations.

In further example, loop four covers testing and can involve iterating over all the available test cases and validating that transformed Java code executes similarly to the PL/SQL. In some examples, error resolution includes adding and improving test cases or improving the transformation process by revising the prompt text or improving the context generation (e.g., as Shown in FIGS. 1A-B).

Side-by-side testing can include the following steps for available test cases:
1. Loading the test data into MongoDB. Compare and confirm that MongoDB has the same data set as used when capturing the behavior of the corresponding PL/SQL.
2. Run the java code using a tool that monitors the change stream and captures all the database changes made by the Java execution and produces a JSON document summarizing these changes. If the JSON documents produced by the PL/SQL and transformed code are similar, then the test passes.
3. If the test fails, i.e., the Java code does not produce the same behavior as the PL/SQL, then analyze failure. In general, debugging should be relatively easy as only a small group of blocks were transformed in the most recent loop limiting any needed changes or update transformation.
4. Once the bug has been identified, the next step is to improve the transformation process or the tests (or both). As discussed the process can include adjusting the prompt, context, and/or implementing another LLM model, etc.
5. Once the transformation process has been improved/adjusted, repeat the PL/SQL to Java transformation and testing of the same block group until the test has passed.

### Head-First Transforming Data-Driven Applications Examples

Many legacy applications rely on stored procedures for a significant portion of their business logic. Testing applications with this architecture is generally difficult. Even if there are full end-to-end tests available, these tests can be too coarse-grained. SQL runtimes do have limited built-in debugging capabilities but developers often have to fall back to trial-and-error. By translating one top level procedure after another, the new code stays fully testable at every point in time. The method is a divide and conquer approach and can be done adaptively with using bigger “chunks” which are then broken up into smaller pieces recursively. The process treats sub procedures as chunks and makes them testable as part of the process. If there are stand-alone tests for a subroutine available already, these are effectively “top level” procedures by themselves.
1) Establish end-to-end test coverage
2) Translate the procedure iteratively
   a) Split stored procedures into smaller procedures
   b) Test that the parts are functionally equivalent to the whole procedure
   c) Record input/output for the first part
      i) Translate and debug the first part potentially by using this procedure recursively
      ii) If the part is still too big
         (1) Split SQL statements into smaller parts
   iii) Translate the next part using the already translated parts as intro

During the transition, there are multiple different modes of testing:
a) Running against the original legacy code base
b) Running against a decomposed legacy code base while recording
c) Running the recorded output against the legacy code base can be an additional validation step
d) Running against the individual parts of the new code base using the recorded data
e) Running against the full code base

### Parallelization of Head-First Transformation

According to some embodiments, while the simplest version of the head-first approach is single-threaded, the transformation work can be parallelized. In one embodiment, parallelization is achieved by providing the translated output of a first portion (A) to the transformation of a subsequent portion (B-A), where B-A represents the code needed to complete the functionality from A to B. The output of the parallelized transformation of B-A should be equal to the output of running the full B on the original input state for the test scenario. This parallelization can be executed using multiple teams or multiple concurrent transformation processes, enabling acceleration of the overall transformation timeline.

Various embodiments do not require running side-by-side tests between the code bases. This allows the system to directly build the new code base, for example, on MongoDB. Dynamic SQL and Long SQL Statement Handling

In various embodiments, the system provides special handling for Dynamic SQL (DSQL) statements and long SQL statements. Dynamic SQL statements, such as those using EXECUTE IMMEDIATE, present unique challenges because the SQL to be executed is constructed at runtime. According to one embodiment, the iterative transformation process repeats steps of slice identification, transformation, project update, and testing until the next EXECUTE IMMEDIATE statement is reached. Once an EXECUTE IMMEDIATE is encountered, the system iteratively implements all permutations of the Dynamic SQL using the transformation steps. This case-by-case translation approach enables handling of the variable nature of dynamically constructed SQL.

For long SQL statements that exceed the effective context window of the translation mechanism (e.g., an LLM), the system may apply the head-first methodology to break down the large statements into smaller, more manageable fragments. In some embodiments, nested SELECT statements and other complex SQL constructs are decomposed into leaf SQL components that can be translated individually and then composed together in the target language.

### Example Considerations: Establish End-to-End Test Coverage

The goal of end-to-end coverage for a top level procedure is to test that the new code is functionally equivalent to the existing SQL implementation. For this, the input and output tables as well as the input and parameters for each top level operation are recorded and a service layer is used that brings the component into the correct state by setting values according to the input tables and then testing each call by initiating the top level operation with the recorded input parameters to then compare the output values and post state of all output tables. In various embodiments, this functionality can be generated using LLM generated for the service layer that calls the two implementations and the actual test code can also be generated and maintained by leveraging the LLM. In one example, the system is configured to record the pre-and post-states, by having the application code call a SQL layer. In various examples, these calls might be hidden in a larger code-base. Where this issue arises or is suspected, rewiring the application to use the service layer can be done with the LLM. The correctness of the rewiring can also be tested by the automated application end tests.

### Example Considerations: Split Stored Procedures into Smaller Blocks

With end-to-end testing on a top level procedure in place, a first attempt at translating the stored procedure can be executed. Experiments have found that debugging the new generated code can be impossible at this scale. As discussed herein to locate the bugs, a given stored procedure P is split into two parts, A and B. By running the first part with the input parameters from the test for P and recording the results after running A the system can create an isolated test for the translation of A (T_A). If the system succeeds in debugging T_A, we can use T_A to test T_B against the full test of T. In cases where it is still not possible to locate the bugs, the initial split elements (e.g., A) can be split further. The optimal chunking of the code depends heavily on the structure of the code base. In one example, aligning chunking the chunk sizes that the transformation process is using is used for an initial benchmark. Further chunking can be invoked when bugs occur. The iterative approach also allows for eventual use of build/repair capabilities. In other embodiments, iteratively splitting a stored procedure into half until the bug can be eliminated is an effective way to debug during execution.

### Example Divide and conquer debugging:

Use head-first approach for a divide and conquer debugging strategy.
1. Test full procedure: FAILURE
2. Test first half: SUCCESS. The issue is in the second half
3. Try to fix the second half. Test second half. FAILURE
4. Split the second half into 3rd and 4th quarter.
5. Test 3rd quarter: FAILURE
6. Fix 3rd quarter: SUCCESS
7. Test Full Procedure: Success

In various embodiments, the system does not need a full translation of T_P, and can start with transcribing just A—which potentially is just a single SQL statement. The system provides the single SQL statement to a translation LLM and then iteratively works through the full code of P (e.g., block by block and sub-block by sub-block, etc.). Further embodiments can execute code parser functions configured to record the input/output parameters and read/writes to tables, such that the correct information can be recorded and replayed. In further examples, the parser can be configured to split the SQL code into multiple components of digestible size. In some embodiments, the system can leverage an LLM to generate code wrapping “ALTER PROCEDURE” statements around a given statement of SQL.

The embodiments of code refactoring approaches incorporated by reference can be used in conjunction, combination, or integrate with head first functionality, examples, embodiments, and/or approaches discussed herein.

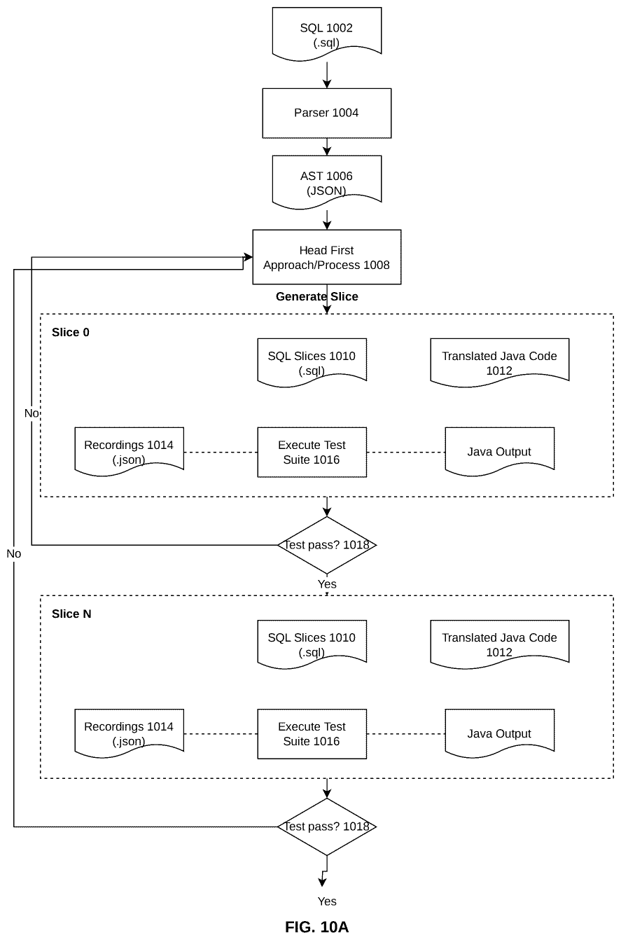

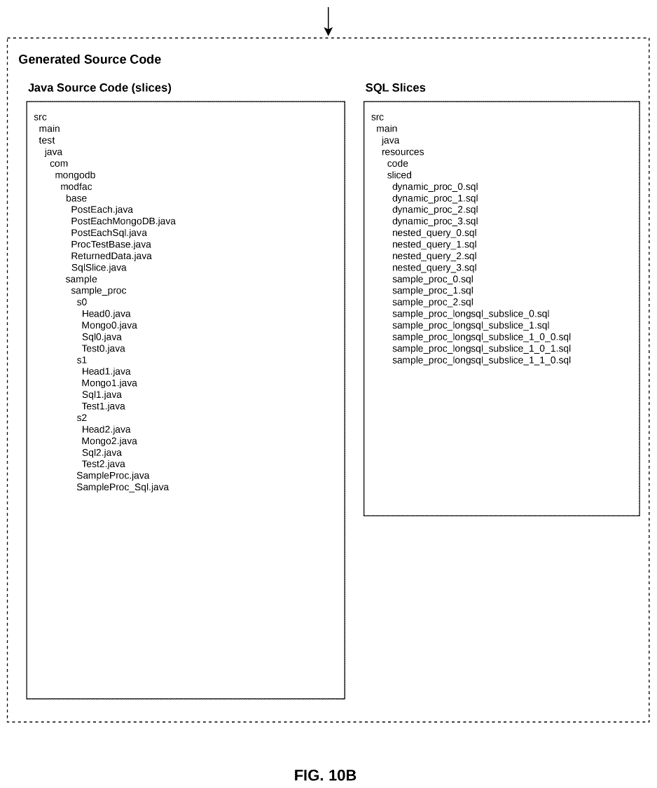

FIG. 10A illustrates a flowchart for a head-first transformation process 1000 for converting legacy code. The process 1000 begins with SQL code input 1002 in a .sql file format, which is provided as input to a parser 1004. The parser 1004 processes the SQL code and generates an Abstract Syntax Tree (AST) 1006 in JSON format. The AST 1006 is then provided to a head-first approach component 1008, which analyzes the parsed code structure and performs a generate slice operation that produces individual code slices for incremental transformation and testing.

The flowchart shows an iterative process that operates on multiple slices, beginning with Slice 0. For each slice, the process generates SQL slices 1010 in .sql format and corresponding translated Java code 1012. Additionally, recordings 1014 in .json format are created to capture the expected behavior. These elements are provided to an execute test suite component 1016, which produces Java output. Following test execution, a test pass decision 1018 determines whether the test passes. If the test does not pass, the process returns to the head-first approach component 1008 for adjustment and retry. If the test passes, the process proceeds to the next slice.

The flowchart demonstrates an incremental transformation methodology where each slice of legacy code is translated, tested, and validated before proceeding to the next slice. This approach enables identification of translation errors at each step, simplifying debugging by isolating issues to the most recently translated slice. The iterative nature of the process, with feedback loops returning to the head-first approach component 1008 upon test failure, supports a test-driven transformation strategy that maintains functional equivalence between the original SQL code and the translated Java code throughout the conversion process.

FIG. 10B illustrates a block diagram of generated source code comprising Java source code slices and SQL slices organized in a hierarchical folder structure. On the left side, the Java source code slices section shows a directory tree with test subdirectories containing Java files such as PostEach.java, ProcTestBase.java, ReturnedData.java, and SqlSlice.java. Sample procedure folders contain numbered subfolders (s0, s1, s2) with corresponding Java files including Head, Mongo, Sql, and Test files for each slice.

On the right side, the SQL slices section displays a separate directory tree with resources folders containing sliced SQL files. The sliced folder contains multiple SQL files organized by type, including dynamic_proc files, nested_query files, sample_proc files, and sample_proc_longsql_subslice files with various numbering patterns. This organization demonstrates how the system manages both the transformed Java code and the original SQL slices in a structured manner that supports incremental testing and validation.

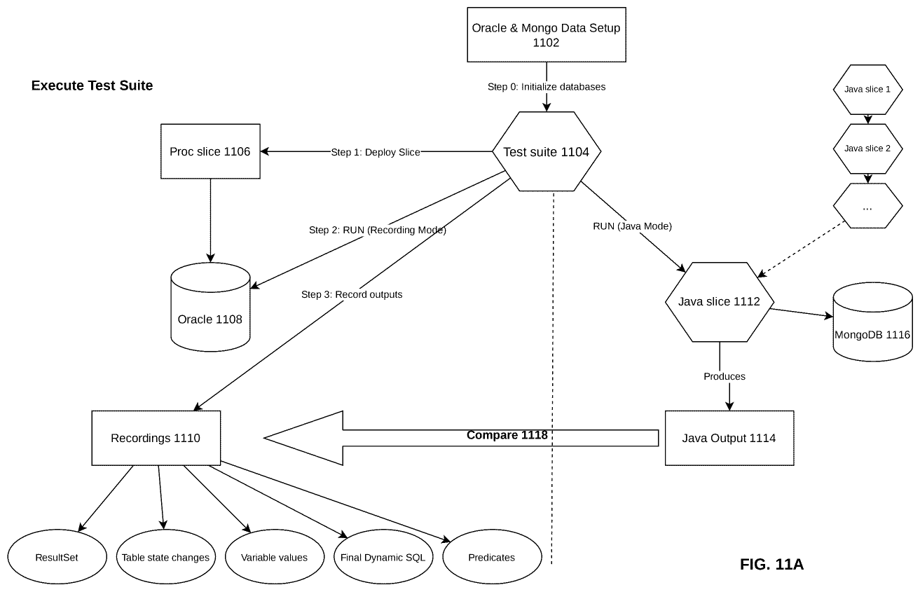

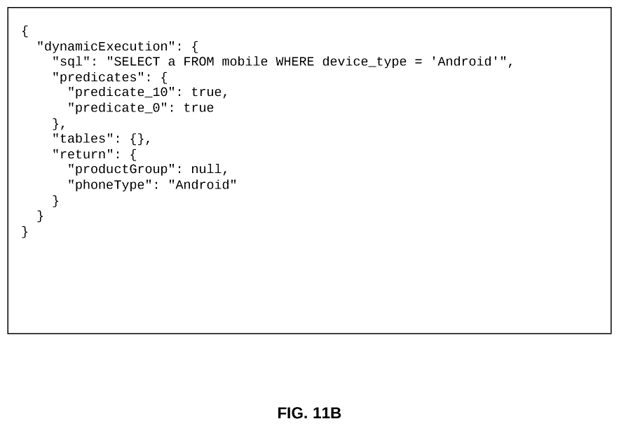

FIG. 11A illustrates a flowchart for an execute test suite process 1100. The process 1100 begins with an Oracle and MongoDB data setup step 1102, which initializes databases. From this initialization, the process flows to a test suite 1104 that orchestrates the subsequent operations. The test suite 1104 initiates deployment of a procedure slice 1106, which connects to an Oracle database 1108. Following deployment, the system runs in recording mode against the Oracle database 1108, and outputs are captured and stored in a recordings component 1110.

The recordings component 1110 stores multiple types of recorded data including result sets, table state changes, variable values, final dynamic SQL, and predicates. These recorded outputs serve as reference data for comparison purposes. In parallel, the test suite 1104 operates in Java mode, where multiple Java slices 1112 representing the translated code segments connect to a consolidated Java slice component that interfaces with a MongoDB database 1116. The Java slice 1112 produces Java output 1114 during execution.

The process 1100 includes a compare operation 1118 where the recordings 1110 from the Oracle execution are compared against the Java output 1114 from the MongoDB execution. This comparison validates that the translated Java code produces functionally equivalent results to the original stored procedure code. A dashed vertical line in the diagram separates the Oracle-based recording side from the Java and MongoDB-based testing side, visually distinguishing the two execution environments being compared.

FIG. 11B illustrates a JSON document structure representing a dynamic execution configuration and its associated metadata. The document contains a dynamicExecution object that includes an sql field storing a SELECT query. Within the dynamicExecution object, a predicates object contains boolean fields that capture the resolved predicate conditions. The document also includes tables and return objects containing fields that capture the return values extracted from the execution context. This structure represents configuration data that captures the results of parsing and evaluating a dynamic SQL statement.

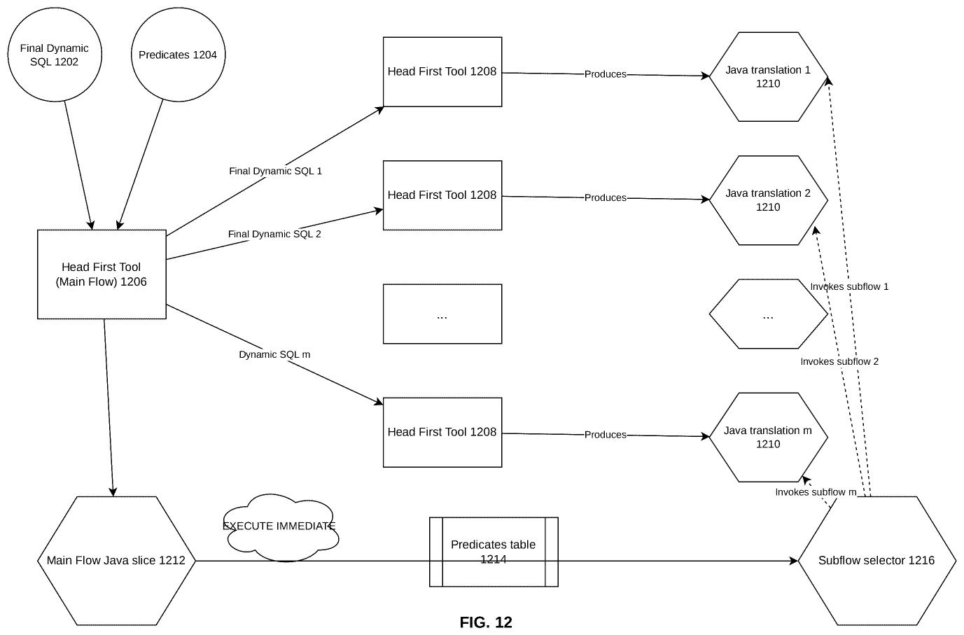

FIG. 12 illustrates a flowchart for a dynamic SQL translation process 1200 that handles multiple permutations of dynamic SQL statements within a stored procedure transformation workflow. The process 1200 depicts how a main flow stored procedure containing dynamic SQL is decomposed and translated into corresponding Java implementations. The flowchart begins with input elements representing final dynamic SQL input 1202 and predicates input 1204, which feed into a head-first tool main flow 1206.

From the head-first tool main flow 1206, the process branches into multiple parallel paths, each representing a different final dynamic SQL permutation. Each dynamic SQL permutation flows to its own dedicated head-first tool instance 1208, which processes the respective dynamic SQL statement and produces corresponding Java translations 1210. The main flow also produces a main flow Java slice 1212, which connects to an EXECUTE IMMEDIATE component indicating the handling of dynamic SQL execution statements within the original stored procedure.

A predicates table 1214 stores the conditions and criteria used to determine which dynamic SQL permutation applies for a given execution scenario. Both the main flow Java slice 1212 and the predicates table 1214 feed into a subflow selector 1216. The subflow selector 1216 determines which subflow to invoke based on the predicates, routing execution to the appropriate translated subflow depending on the runtime conditions. This architecture enables incremental testing of each dynamic SQL variation while maintaining functional equivalence with the original stored procedure behavior.

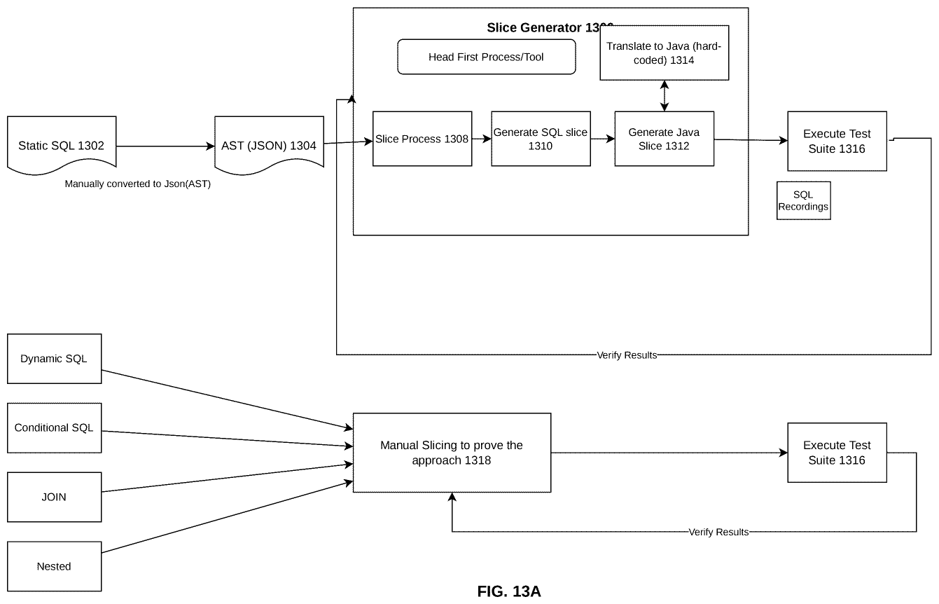

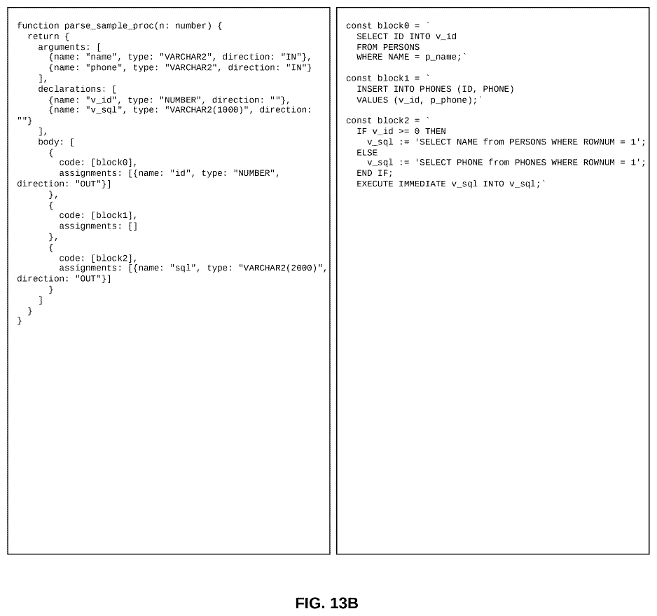

FIG. 13A illustrates a flowchart for a head-first transformation process 1300 for legacy code conversion. The process 1300 begins with static SQL 1302, which is converted to an Abstract Syntax Tree (AST) 1304 represented in JSON format. This AST 1304 serves as the input to a slice generator 1306, which contains multiple processing stages including a slice process 1308 and a generate Java slice operation 1312 that produces Java code and a test suite as outputs.

The output from the slice generator 1306 proceeds to an execute test suite 1316, which produces SQL recordings as an output artifact. A verify results feedback loop connects from the execute test suite 1316 back to earlier stages in the process, enabling iterative validation and correction of the transformation. The flowchart also depicts a parallel processing path for more complex SQL types including dynamic SQL, conditional SQL, JOIN, and nested SQL, each flowing into a manual slicing component 1318 with its own execute test suite and verify results feedback loop.

FIG. 13B illustrates a code parsing and transformation diagram showing the decomposition of a sample stored procedure into structured data representations and corresponding code blocks. On the left side, a function accepts parameters and returns an object containing arguments, declarations, and body sections. The arguments section includes entries with name, type, and direction properties. The declarations section contains variable definitions, and the body section contains an array of code blocks with assignments. On the right side, constant declarations define the actual SQL and procedural code corresponding to each block, including SELECT statements, INSERT statements, and conditional logic with IF statements and EXECUTE IMMEDIATE statements.

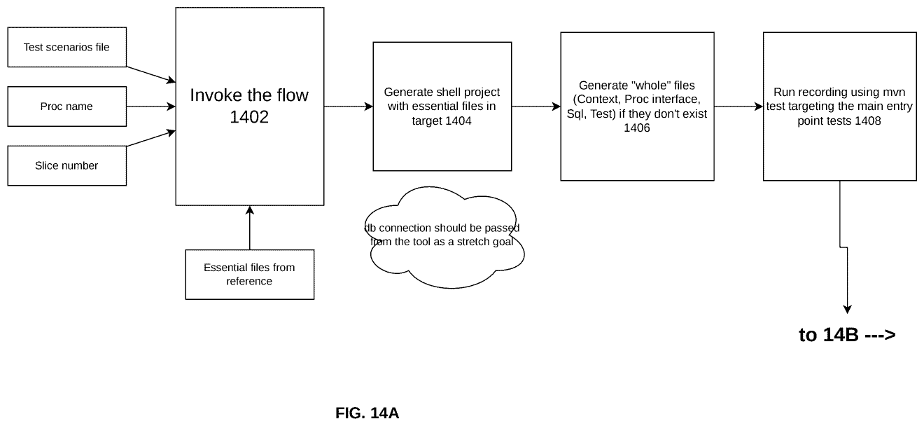

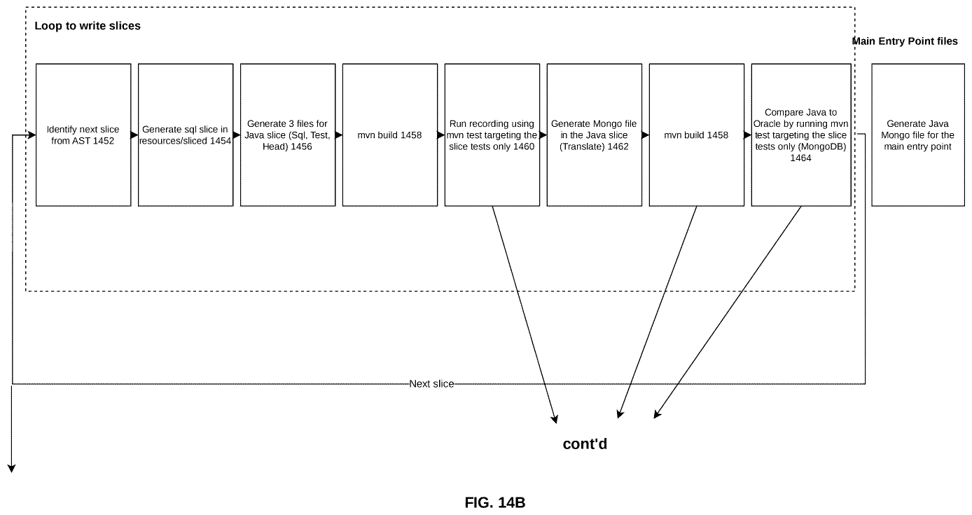

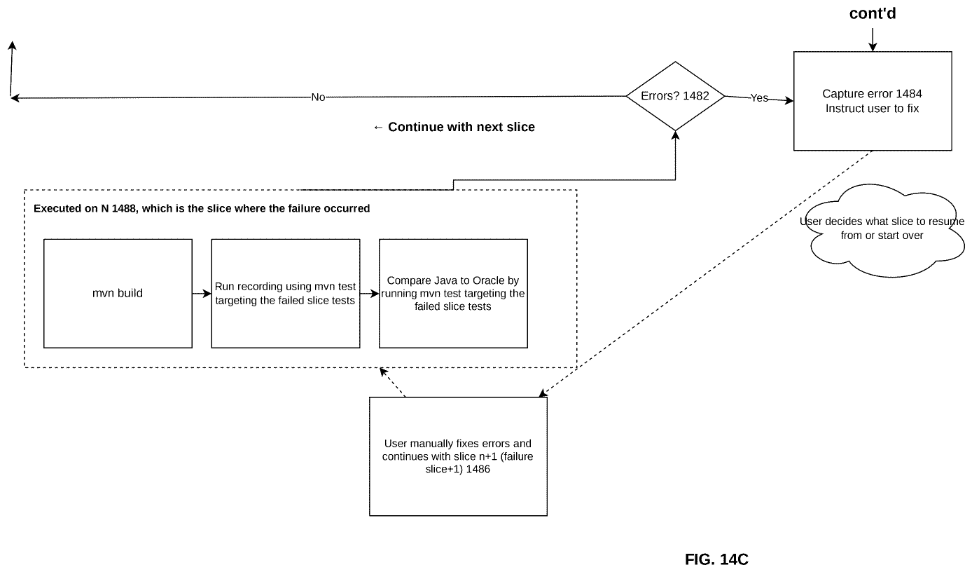

FIG. 14A illustrates a flowchart for an invoke the flow process 1400 used during legacy code transformation. The process 1400 receives several inputs including essential files from a reference source, a slice number, a procedure name, and a test scenarios file. These inputs feed into the main invoke the flow component 1402, which serves as the central orchestration element for the transformation process. From this component, the process proceeds to generate a shell project step 1404 with essential files in a target location, establishing the foundational project structure required for subsequent transformation activities.

The process then advances to generate whole files step 1406 including context, procedure interface, SQL, and test components. A decision point follows this generation step to determine whether these files exist. If the files do not exist, the process proceeds to run recording step 1408 using the main entry point tests. This recording step captures the expected behavior of the original code for later comparison. The overall structure demonstrates an incremental approach where the transformation tool validates the existence of necessary artifacts before proceeding with recording operations.

FIG. 14B illustrates a flowchart for a loop process 1450 used to write slices during legacy code transformation. The process begins with an identify next slice step 1452 from an Abstract Syntax Tree (AST). Following this identification, the process performs a generate SQL slice step 1454 in a resources directory and a generate Java files step 1456 for the Java slice including SQL, test, and head components. A build step 1458 is then executed to compile the generated code (e.g., leveraging build architecture including MAVEN), followed by a run recording step 1460 (e.g., leveraging MAVEN test with material produced) targeting the slice tests only.

The process then performs a generate Mongo file step 1462 in the Java slice, which involves a translation step. Another build step 1458 (e.g., using MAVEN) is executed following the MongoDB file generation. The process then performs a compare Java to Oracle step 1464 by running test (e.g., MAVEN test) targeting the slice tests only using MongoDB. The loop continues back to identify next slice step 1452, repeating the sequence for subsequent slices until all slices are processed. Outside the main loop, the process includes generating a Java MongoDB file for the main entry point.

FIG. 14C illustrates a flowchart for a head-first transformation process 1480 for converting legacy code, similar to FIG. 10A. The process 1480 begins with SQL code provided as input to a parser, which generates an Abstract Syntax Tree (AST) in JSON format. The AST is provided to a head-first approach component that performs slice generation for incremental transformation and testing. The flowchart shows an iterative process operating on multiple slices, with each slice generating SQL slices, translated Java code, and recordings that are processed by an execute test suite component.

Following test execution, an errors decision 1482 determines whether to continue to the next slice upon success or return for correction upon failure. If errors are detected, a capture error step 1484 records the error information, and a user fix step 1486 within a failure slice execution container 1488 enables correction of the issues. The flowchart demonstrates the incremental transformation methodology where each slice of legacy code is translated, tested, and validated before proceeding to the next slice, enabling identification of translation errors at each step and simplifying debugging by isolating issues to the most recently translated slice.

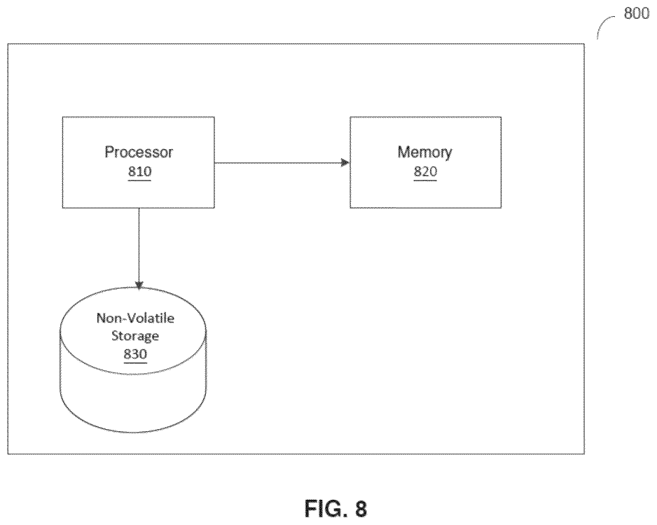

Additionally, an illustrative implementation of a special purpose computer system 800, that may be specially programmed to improve over conventional systems, to be used in connection with any of the embodiments of the disclosure provided herein is shown in FIG. 8. The computer system 800 may include one or more processors 810 and one or more articles of manufacture that comprise non-transitory computer-readable storage media (e.g., memory 820 and one or more non-volatile storage 830). The processor 810 may control writing data to and reading data from the memory 820 and the non-volatile storage device 830 in any suitable manner. To perform any of the functionality described herein (e.g., secure execution, proxied execution, sandboxed execution, etc.), the processor 810 may execute one or more processor-executable instructions stored in one or more non-transitory computer-readable storage media (e.g., the memory 820), which may serve as non-transitory computer-readable storage media storing processor-executable instructions for execution by the processor 810.

The terms “program” or “software” or “app” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationships between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

### Numbered Embodiments

1. A system embodiment for transforming computer programs, the system comprising: at least one processor operatively connected to a memory, the at least one processor when executing configured to: identify a plurality of slices from a plurality of programs, where a respective slice is defined as a subdivision of a respective program; input a first slice of the plurality of slices into a large language model trained to generate object-oriented code (e.g., Java) from input lines of code, and generate a transformed first code slice as output; test the transformed first code slice; and upon validation continue transformation and testing of subsequent ones of the plurality of slices.
2. The system of any embodiment, wherein the at least one processor is configured to analyze the plurality of programs within code for an application.
3. The system of any embodiment, wherein the at least one processor is configured to test the transformed slice and validate operation of the transformed slice.
4. The system of any embodiment, wherein the at least one processor is configured to test the transformed slice and in response to failure adjust the transformation parameters of the first code slice, the adjusted parameters including at least one of or any combination of: re-sizing the first slice into at least two slices and using the first re-sized slice as the first slice for subsequent operation or providing context as a prompt (e.g., code summary, prior code, state, state variables, among other options).
5. The system of any embodiment, wherein the at least one processor is configured to generate a transformed second code slice, and test the combination of the transformed first and second code slice.
6. The system of any embodiment, wherein the translation of each slice can be validated individually.
7. The system of any embodiment, wherein the at least one processor is configured to continue transformation and testing of subsequent ones of the plurality of slices until the translated slices cover the capabilities of the initial computer program.
8. The system of any embodiment, wherein the at least one processor is configured to identify the plurality of slices by building an abstract syntax tree using a parser.
9. The system of any embodiment, wherein the parser comprises an ANTLR parser configured to parse PL/SQL code.
10. The system of any embodiment, wherein the at least one processor is configured to decompose a conditional statement into a plurality of slices comprising: a first slice configured to evaluate a condition, a second slice configured to handle a TRUE branch of the condition, and a third slice configured to handle a FALSE branch of the condition.
11. The system of any embodiment, wherein the at least one processor is configured to detect a Dynamic SQL statement and iteratively implement permutations of the Dynamic SQL statement.
12. The system of any embodiment, wherein testing the transformed first code slice comprises performing a side-by-side comparison that validates at least one of: data content equivalence, type matching, result set size, order preservation, NULL handling, or error conditions.
13. The system of any embodiment, wherein the at least one processor is configured to automatically integrate the transformed first code slice into a target project structure.
14. A method for transforming computer programs, the method comprising: identifying, by at least one processor, a plurality of slices from a plurality of programs, where a respective slice is defined as a subdivision of a respective program; inputting a first slice of the plurality of slices into a large language model trained to generate object-oriented code from input lines of code; generating a transformed first code slice as output from the large language model; testing the transformed first code slice; and upon validation, continuing transformation and testing of subsequent ones of the plurality of slices.
15. The method of any embodiment, wherein identifying the plurality of slices comprises building an abstract syntax tree using a parser to decompose complex SQL statements into manageable units.
16. The method of any embodiment, further comprising decomposing a conditional statement into separate slices for a TRUE branch and a FALSE branch.
17. The method of any embodiment, further comprising detecting a Dynamic SQL statement and iteratively implementing permutations of the Dynamic SQL statement.
18. The method of any embodiment, further comprising parallelizing the transformation by providing a translated output of a first portion to a transformation of a subsequent portion.
19. A non-transitory computer-readable medium storing instructions that, when executed by at least one processor, cause the at least one processor to: identify a plurality of slices from a plurality of programs, where a respective slice is defined as a subdivision of a respective program; input a first slice of the plurality of slices into a large language model trained to generate object-oriented code from input lines of code; generate a transformed first code slice as output; test the transformed first code slice by performing a side-by-side comparison between execution of original code and execution of the transformed first code slice; and upon validation, continue transformation and testing of subsequent ones of the plurality of slices.
20. The non-transitory computer-readable medium of any embodiment, wherein the instructions further cause the at least one processor to automatically integrate each transformed code slice into a target project structure.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements.

This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having the same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed:

1. A system for transforming computer programs, the system comprising:
at least one processor operatively connected to a memory, the at least one processor when executing configured to:
identify a plurality of slices from a plurality of programs, where a respective slice is defined as a subdivision of a respective program;
input a first slice of the plurality of slices into a large language model trained to generate object-oriented code from input lines of code, and generate a transformed first code slice as output;
test the transformed first code slice; and
upon validation continue transformation and testing of subsequent ones of the plurality of slices.

2. The system of claim 1, wherein the at least one processor is configured to analyze the plurality of programs within code for an application.

3. The system of claim 1, wherein the at least one processor is configured to test the transformed slice and validate operation of the transformed slice.

4. The system of claim 1, wherein the at least one processor is configured to test at least one transformed slice and in response to failure adjust transformation parameters of at least one code slice, the adjusted parameters including at least one of: re-sizing the at least one code slice into at least two slices and using respective ones of the at least two slices for subsequent operation, or providing context as a prompt.

5. The system of claim 1, wherein at the least one processor is configured to generate a transformed second code slice, and test the combination of the transformed first and second code slice.

6. The system of claim 1, wherein the translation of each slice is validated individually.

7. The system of claim 1, wherein the at least one processor is configured to continue transformation and testing of subsequent ones of the plurality of slices until the translated slices cover the capabilities of the initial computer program.

8. A method for transforming computer programs, the method comprising:
identifying, by at least one processor, a plurality of slices from a plurality of programs, where a respective slice is defined as a subdivision of a respective program;
inputting, by the at least one processor, a first slice of the plurality of slices into a large language model trained to generate object-oriented code from input lines of code;
generating, by the at least one processor, a transformed first code slice as output from the large language model;
testing, by the at least one processor, the transformed first code slice; and
upon validation, continuing transformation and testing, by the at least one processor, of subsequent ones of the plurality of slices.

9. The method of claim 8, wherein the method further comprises analyzing the plurality of programs within code for an application.

10. The method of claim 8, wherein the method further comprises testing the transformed slice and validating operation of the transformed slice.

11. The method of claim 8, wherein the method further comprises testing at least one transformed slice and in response to failure adjusting the transformation parameters of at least one code slice, the adjusted parameters including at least one of: re-sizing the at least one code slice into at least two slices and using respective ones of the at least two slices for subsequent operation, or providing context as a prompt.

12. The method of claim 8, wherein the method further comprises generating a transformed second code slice, and testing the combination of the transformed first and second code slice.

13. The method of claim 8, wherein the translation of each slice is validated individually.

14. The method of claim 8, wherein the method further comprises continuing transformation and testing of subsequent ones of the plurality of slices until the translated slices cover the capabilities of the initial computer program.

15. A non-transitory computer-readable medium storing instructions that, when executed by at least one processor, cause the at least one processor to:
identify a plurality of slices from a plurality of programs, where a respective slice is defined as a subdivision of a respective program;
input a first slice of the plurality of slices into a large language model trained to generate object-oriented code from input lines of code, and generate a transformed first code slice as output;
test the transformed first code slice; and
upon validation, continue transformation and testing of subsequent ones of the plurality of slices.

16. The non-transitory computer-readable medium of claim 15, wherein the instructions further cause the at least one processor to analyze the plurality of programs within code for an application.

17. The non-transitory computer-readable medium of claim 15, wherein the instructions further cause the at least one processor to test the transformed slice and validate operation of the transformed slice.

18. The non-transitory computer-readable medium of claim 15, wherein the instructions further cause the at least one processor to test at least one transformed slice and in response to failure adjust the transformation parameters of at least one code slice, the adjusted parameters including at least one of: re-sizing the at least one code slice into at least two slices and using respective ones of the at least two slices for subsequent operation, or providing context as a prompt.

19. The non-transitory computer-readable medium of claim 15, wherein the instructions further cause the at least one processor to generate a transformed second code slice, and test the combination of the transformed first and second code slice.

20. The non-transitory computer-readable medium of claim 15, wherein the translation of each slice is validated individually.
